(19) United States
(12) Patent Application Publication
(10) Pub. No.: US 2015/0019290 A1
(43) Pub. Date: Jan. 15, 2015

(54) SYSTEMS AND METHODS FOR REPRESENTING CONSUMER BEHAVIOR

(71) Applicant: Ross M. Keelan Downton, Arlington, VA (US)

(72) Inventor: Ross M. Keelan Downton, Arlington, VA (US)

(73) Assignee: CAPITAL ONE FINANCIAL CORPORATION, McLean, VA (US)

(21) Appl. No.: 14/288,985

(22) Filed: May 28, 2014

Related U.S. Application Data
(60) Provisional application No. 61/845,627, filed on Jul. 12, 2013.

(51) Int. Cl. G06Q 30/02

(52) U.S. Cl. CPC G06Q 30/0202
USPC 705/7.31

(57) ABSTRACT

The disclosed embodiments include systems and methods for representing consumer behavior. In one embodiment, a system may include one or more memory devices storing software instructions, and one or more processors configured to execute the software instructions to receive consumer transaction data associated with financial transactions occurring with a first merchant and financial transactions occurring with a second merchant. The one or more processors may also be configured to calculate a relative influence score between the first and second merchants based at least on the consumer transaction data, and generate a graphical representation of the first and second merchants and the relative influence score.

### PRIORITY CLAIM

This application claims priority under 35 U.S.C. §119 to U.S. Provisional Application No. 61/845,627, filed on Jul. 12, 2013, which is expressly incorporated herein by reference in its entirety.

### TECHNICAL FIELD

The disclosed embodiments generally relate to systems and methods for representing consumer behavior and, more particularly, to systems and methods for calculating the influence one or more merchants has on a consumer, as well as representing consumer behavior based on the calculated influence.

### BACKGROUND

Consumers often travel to so-called brick-and-mortar merchant locations to make transactions, such as purchases of goods or services. Merchants may be located anywhere in a particular region, depending on the physical makeup of the region. Many times, consumers will travel to more than one merchant during a particular trip. The particular merchants in the region where a consumer makes one transaction may influence the consumer's choices regarding future transactions. In this way, the presence of merchants in a particular area may help influence sales for other merchants in the area.

Merchant influence may be present when a consumer travels to a specific shopping mall, a certain street or block, or even a particular city that has all or many of the merchants at which the consumer is seeking to make transactions. In other situations, consumers may travel to a certain area to transact with one or more specific merchants, with the expectation that they can complete other transactions at other merchants nearby. In these situations, a consumer may be indifferent to the particular merchant at which they make a secondary purchase, and the merchants that happen to be in the area may influence the consumer's behavior.

Currently, data regarding consumer transactions may provide certain information regarding consumer behavior, such as the physical locations at which individual consumers have made transactions. There is a need to better harness this data so that it may be useful in making decisions and predictions that involve future consumer behavior.

### SUMMARY

Consistent with disclosed embodiments, systems, methods, and computer-readable media are provided for representing consumer behavior.

Consistent with a disclosed embodiment, a system for representing consumer behavior is provided. The system may include one or more memory devices storing software instructions. The system may also include one or more processors configured to execute the software instructions to receive consumer transaction data associated with financial transactions occurring with a first merchant and financial transactions occurring with a second merchant. The one or more processors may also be configured to calculate a relative influence score between the first and second merchants based at least on the consumer transaction data, and generate a graphical representation of the first and second merchants and the relative influence score.

Consistent with another disclosed embodiment, a method for representing consumer behavior is provided. The method may include receiving, by one or more processors, consumer transaction data associated with financial transactions occurring with a first merchant and financial transactions occurring with a second merchant. The method may also include calculating, by the one or more processors, a relative influence score between the first and second merchants based on the consumer transaction data, and generating, by the one or more processors, a graphical representation of the first and second merchants and the relative influence score. Generating a graphical representation may include generating a merchant map that depicts the relative location of each of the first and second merchants, modifying the merchant map to include a boundary associated with each of the first and second merchants, and modifying at least the boundary associated with the first merchant to reflect the relative influence score.

Consistent with another disclosed embodiment, a tangible computer-readable medium storing instructions for representing consumer behavior is provided. The instructions may be operable to cause one or more processors to perform operations consistent with the method described above.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate disclosed embodiments and, together with the description, serve to explain the disclosed embodiments. In the drawings:

FIG. 1 is a block diagram of an exemplary system, consistent with disclosed embodiments;

FIG. 2 is a block diagram of an exemplary server, consistent with disclosed embodiments;

FIG. 3 is a flowchart of an exemplary process for using transaction data to represent consumer behavior, consistent with disclosed embodiments;

FIG. 4 is a flowchart of an exemplary process for generating a relative influence matrix, consistent with disclosed embodiments;

FIG. 5 is a flowchart of an exemplary process for representing consumer behavior as a merchant influence map, consistent with disclosed embodiments;

FIG. 6 is an illustration of an exemplary merchant map including a predictive model, consistent with disclosed embodiments;

FIG. 7 is a schematic illustration of exemplary scenarios for creating a merchant influence map, consistent with disclosed embodiments; and

FIGS. 8-11 are illustrations of exemplary merchant influence maps, consistent with disclosed embodiments.

### DETAILED DESCRIPTION

Reference will now be made in detail to the disclosed embodiments, examples of which are illustrated in the accompanying drawings. Wherever convenient, the same reference numbers will be used throughout the drawings to refer to the same or like parts.

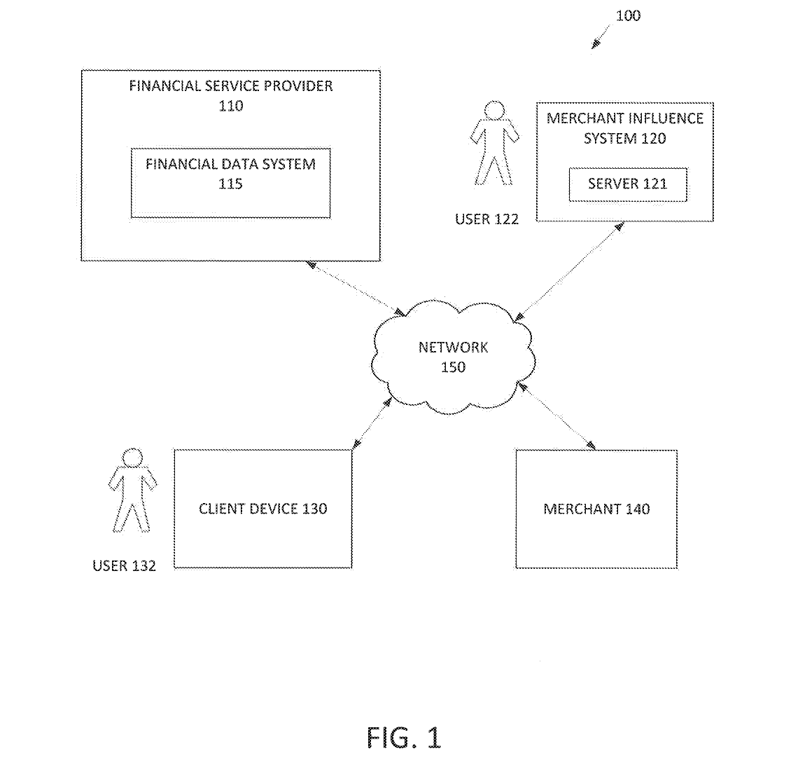

FIG. 1 is a block diagram illustrating an exemplary system 100 for performing one or more operations, consistent with the disclosed embodiments. In one embodiment, system 100 may include a financial service provider system 110, a merchant influence system 120, a client device 130, a merchant 140, and a network 150. The components and arrangement of the components included in system 100 may vary. Thus, system 100 may further include one or more of the components of system 100 or other components that perform or assist in the performance of one or more processes consistent with the disclosed embodiments.

Components of system 100 may be computing systems configured to represent consumer behavior, consistent with disclosed embodiments. As further described herein, components of system 100 may include one or more computing devices (e.g., computer(s), server(s), etc.), memory storing data and/or software instructions (e.g., database(s), memory devices, etc.), and other known computing components. In some embodiments, the one or more computing devices are configured to execute software instructions stored on one or more memory devices to perform one or more operations consistent with the disclosed embodiments. Components of system 100 may be configured to communicate with one or more other components of system 100, including financial service provider system 110, merchant influence system 120, client device 130, and/or merchant 140. In certain aspects, users may operate one or more components of system 100 to initiate one or more operations consistent with the disclosed embodiments. In some aspects, the one or more users may be employees of, or associated with, the entity corresponding to the respective component(s) (e.g., someone authorized to use the underlying computing systems or otherwise act on behalf of the entity). In other aspects, the user may not be an employee or otherwise associated with underlying entity. In still other aspects, the user may itself be the entity associated with the respective component (e.g., user 132 operating client device 130).

Financial service provider 110 may be an entity that provides financial services. For example, financial service provider 110 may be a bank, credit union, credit card issuer, or other type of financial service entity that generates, provides, manages, and/or maintains financial service accounts for one or more users. Financial service accounts may include, for example, credit card accounts, checking accounts, savings accounts, loan accounts, reward accounts, and any other types of financial service account known to those skilled in the art. Financial service accounts may be associated with electronic accounts, such as a digital wallet or similar account that may be used to perform electronic transactions, such as purchasing goods and/or services online. Financial service accounts may also be associated with physical financial service account cards, such as a credit or check card that a user may carry on their person and use to perform financial service transactions, such as purchasing goods and/or services at a point of sale (POS) terminal. Financial service provider 110 may include infrastructure and components that are configured to generate and provide financial service accounts and financial service account cards (e.g., credit cards, check cards, etc.). Financial service provider 110 may also include infrastructures and components that are configured to store transactional data associated with the financial service accounts. For example, financial service provider 110 may include one or more financial data systems 115.

Financial data system 115 may be a computing system configured to collect, store, and analyze financial data. For example, financial data system 115 may be a server configured to communicate with other components of system 100 to receive and provide financial data. Financial data may include any information related to financial service accounts, customer information, transaction information, or other information relevant to one or more of financial service provider 110, merchant influence system 120, client device 130, and merchant 140.

Merchant influence system 120 may be a computing system configured to analyze financial data to represent consumer behavior consistent with disclosed embodiments, as further described herein. In one embodiment, merchant influence system 120 may be part of a financial service provider system 110. In other embodiments, merchant influence system 120 may be a separate entity that performs functions to analyze transaction data and represent consumer behavior, consistent with disclosed embodiments.

According to some embodiments, merchant influence system 120 may include one or more computing devices (e.g., server(s)), memory storing data and/or software instructions (e.g., database(s), memory devices, etc.) and other known computing components. Merchant influence system 120 may include a merchant influence server 121. Merchant influence server 121 may be configured to perform functions consistent with exemplary methods disclosed herein. Merchant influence server 121 may be configured to communicate with one or more components of system 100, such as financial service provider 110, financial data system 115, client device 130, and/or merchant 140. Merchant influence server 121 may directly access memory devices of financial data system 115 to retrieve, for example, financial transaction data associated with consumers or merchants. Merchant influence system 120 may be configured to provide interactive tools that include interface(s) accessible by users over a network (e.g., the Internet).

In exemplary embodiments, a user 122 may operate one or more components of merchant influence system 120 to perform one or more operations consistent with the disclosed embodiments. User 122 may be an employee of, or associated with, an entity that uses merchant influence system 120. For example, in an embodiment in which merchant influence system 120 is a component of financial service provider 110, user 122 may be an employee or, or associated with, financial service provider 110 (e.g., someone authorized to operate merchant influence system 120). User 122 may provide certain user inputs to merchant influence system 120, which merchant influence system 120 may use to provide a representation of consumer behavior that meets the requirements of user 122.

Client device 130 may be one or more computing devices that are configured to execute software instructions for performing one or more operations consistent with the disclosed embodiments. Client device 130 may be a desktop computer, a laptop, a server, a mobile device (e.g., tablet, smartphone, etc.), a car's heads-up display, a wearable screen or headset, and/or any other type of computing device. Client device 130 may include one or more processors configured to execute software instructions stored in memory, such as memory included in client device 130. Client device 130 may include software that, when executed by a processor, performs known Internet-related communication and content display processes. For instance, client device 130 may execute browser software that generates and displays interface screens including content on a display device included in, or connected to, client device 130. The disclosed embodiments are not limited to any particular configuration of client device 130. For instance, client device 130 may be a mobile device that stores and executes mobile applications that provide financial-service-related functions offered by financial service provider 110, such as an application for receiving merchant recommendations from financial service provider 110.

In one embodiment, a user 132 may use client device 130 to perform one or more operations consistent with the disclosed embodiments. In one aspect, user 132 may be a customer of financial service provider 110. For instance, financial service provider 110 may maintain a financial service account (e.g., credit card account) for user 132 that user 132 may use to purchase goods and/or services online or at brick-and-mortar locations associated with a merchant (e.g., merchant 140). In other embodiments, user 132 may be a potential customer of financial service provider 110 or may not be affiliated with financial service provider 110 from the perspective of user 132 and/or the perspective of financial service provider 110. For example, user 132 may be a consumer who does not have a financial service account with financial service provider 110, but installs an application on client device 130 to receive services (e.g., merchant deals and/or recommendations) from financial service provider 110.

Merchant 140 may be an entity that provides goods and/or services (e.g., a retail store). While FIG. 1 shows one merchant 140 in system 100, the disclosed embodiments may be implemented in a system involving a single merchant 140 or multiple merchants (e.g., two or more merchants). In one embodiment, merchant 140 may include brick-and-mortar location(s) that a consumer (e.g., user 132) may physically visit and purchase goods and services. Such physical locations may include computing devices that perform financial service transactions with consumers (e.g., POS terminal(s), kiosks, etc.). Merchant 140 may also include a merchant who provides electronic shopping mechanisms, such as a website or a similar online location that consumers (e.g., user 132) may access using a computer (e.g., client device 130) through browser software or similar software. Merchant 140 may include computing devices that may include back and/or front-end computing components that store consumer transaction data and execute software instructions to perform operations consistent with the disclosed embodiments, such as computers that are operated by employees of merchant 140 (e.g., back-office systems, etc.).

In accordance with certain aspects of the disclosed embodiments, one or more computing devices associated with merchant 140 may be configured to gather consumer transaction data associated with the business conducted at merchant 140. Consumers may make payments with electronic payment cards (e.g., credit card or debit card issued by financial service provider 110) for the goods/services provided by merchant 140. In some other aspects, consumers may also make the payment by cash or other type of payment that does not immediately establish any electronic record, but which may be entered at a later time. In both situations, one or more computing devices associated with merchant 140 may be configured to store the consumer transaction data and provide the data to financial service provider 110 and/or merchant influence system 120.

Network 150 may be any type of network configured to provide communications between components of system 100. For example, network 150 may be any type of network (including infrastructure) that provides communications, exchanges information, and/or facilitates the exchange of information, such as the Internet, a Local Area Network, or other suitable connection(s) that enables the sending and receiving of information between the components of system 100. In other embodiments, one or more components of system 100 may communicate directly through a dedicated communication link(s) (not shown), such as a link between financial service provider 110 and client device 130 and between financial service provider 110 and merchant 140.

It is to be understood that the configuration and boundaries of the functional building blocks of system 100 has been defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. For example, financial data system 115 may constitute a part of components of system 100 other than those specifically described (e.g., merchant influence system 120, client device 130, and/or merchant(s) 140) or may constitute a part of multiple components of system 100 (i.e., a distributed system). Such alternatives fall within the scope and spirit of the disclosed embodiments.

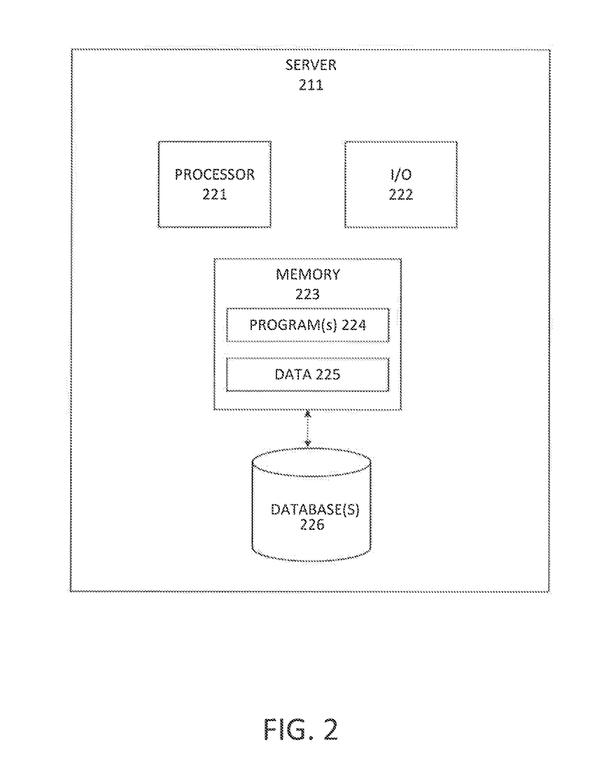

FIG. 2 shows an exemplary server 211 for implementing embodiments consistent with the present disclosure. Variations of server 211 may be used by financial service provider 110, financial data system 115, merchant influence system 120, client device 130, and/or merchant 140.

In one embodiment, server 211 may include one or more processors 221, one or more memories 223, and one or more input/output (I/O) devices 222. Alternatively, server 211 may take the form of a mobile computing device, general purpose computer, a mainframe computer, or any combination of these components. According to some embodiments, server 211 may comprise web server(s) or similar computing devices that generate, maintain, and provide web site(s) consistent with disclosed embodiments. Server 211 may be standalone, or it may be part of a subsystem, which may be part of a larger system. For example, server 211 may represent distributed servers that are remotely located and communicate over a network (e.g., network 150) or a dedicated network, such as a LAN. Server 211 may correspond to financial data system 115, merchant influence server 121, or separately to any server or computing device included in financial service provider 110, client device 130, and/or merchant 140.

Processor 221 may include one or more known processing devices, such as a microprocessor from the Pentium™ or Xeon™ family manufactured by Intel™, the Turion™ family manufactured by AMD™, or any of various processors manufactured by Sun Microsystems. The disclosed embodiments are not limited to any type of processor(s) configured in server 211.

Memory 223 may include one or more storage devices configured to store instructions used by processor 221 to perform functions related to disclosed embodiments. For example, memory 223 may be configured with one or more software instructions, such as program(s) 224 that may perform one or more operations when executed by processor 221. The disclosed embodiments are not limited to separate programs or computers configured to perform dedicated tasks. For example, memory 223 may include a single program 224 that performs the functions of the server 211, or program 224 could comprise multiple programs. Additionally, processor 221 may execute one or more programs located remotely from server 211. For example, financial service provider system 110, merchant influence system 120, client device 130, and/or merchant 140, may, via server 211, access one or more remote programs that, when executed, perform functions related to certain disclosed embodiments. Memory 223 may also store data 225 that may reflect any type of information in any format that the system may use to perform operations consistent with the disclosed embodiments.

I/O devices 222 may be one or more devices configured to allow data to be received and/or transmitted by server 211. I/O devices 222 may include one or more digital and/or analog communication devices that allow server 211 to communicate with other machines and devices, such as other components of system 100.

Server 211 may also be communicatively connected to one or more database(s) 226. Server 211 may be communicatively connected to database(s) 226 through network 150. Database 226 may include one or more memory devices that store information and are accessed and/or managed through server 211. By way of example, database(s) 226 may include Oracle™ databases, Sybase™ databases, or other relational databases or non-relational databases, such as Hadoop sequence files, HBase, or Cassandra. The databases or other files may include, for example, data and information related to the source and destination of a network request, the data contained in the request, etc. Systems and methods of disclosed embodiments, however, are not limited to separate databases. In one aspect, system 200 may include database 226. Alternatively, database 226 may be located remotely from the system 200. Database 226 may include computing components (e.g., database management system, database server, etc.) configured to receive and process requests for data stored in memory devices of database(s) 226 and to provide data from database 326.

In some embodiments, database 226 may be a part of financial data system 115. For example, database 226 may be configured to store consumer transaction data received by financial service provider 110 from merchant(s) 140. In other embodiments, database 226 may store consumer transaction data associated with financial service accounts managed and/or maintained by financial service provider 110. According to the illustrated embodiments, processor 221 may be configured to retrieve consumer transaction data by analyzing data associated with the financial service accounts stored in database 226, and store the obtained consumer transaction data in database 226.

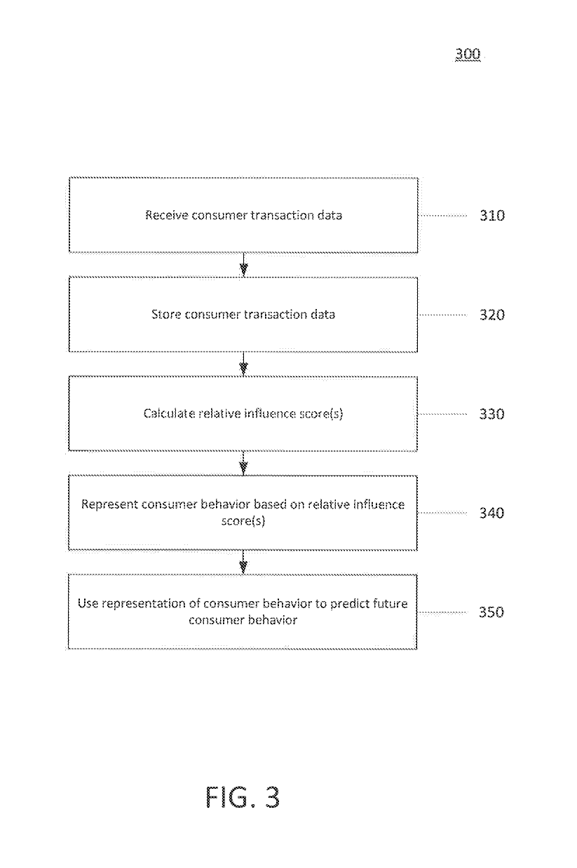

FIG. 3 is a flowchart of an exemplary process 300 for using consumer transaction data to represent consumer behavior, consistent with the disclosed embodiments. In some embodiments, merchant influence system 120 may be configured to perform process 300 to provide a representation of consumer behavior to an entity. In certain aspects, server 121 may be configured to execute software instructions that perform one or more of the operations of process 300.

In exemplary embodiments, certain components of system 100 may be configured to receive consumer transaction data (step 310). In some embodiments, financial data system 115 may be configured to receive consumer transaction data associated with the financial service accounts that financial service provider 110 manages and/or maintains. For example, a customer of financial service provider 110, a user (e.g., user 132) may have one or more debit cards, credit cards, and/or other financial service account maintained by financial service provider 110. User 132 may use the financial service account maintained by financial service provider 110 to perform purchase transactions and make payments at various merchants (e.g., merchant 140), either at a point-of-sale location in the merchant location or via an online store. Financial data system 115 may be configured to receive the transaction data associated with the financial service accounts and compile it into consumer transaction data reflecting transaction activities of a plurality of consumers (e.g., user 132).

In certain embodiments, merchant influence server 121 may be configured to execute software instructions that enable it to receive the consumer transaction data from financial service provider 110 (via financial data system 115). For example, financial service provider 110 may be an entity (e.g., a bank) that collects consumer transaction data. Financial service provider 110 (via, e.g., financial data system 115 or some other computer component) may collect data relating to consumer transaction data including, for example, the consumer transaction data associated with the financial service accounts that financial service provider 110 and/or another entity generates and manages. Financial service provider 110 (via, e.g., financial data system 115) may be configured to provide the collected consumer transaction data to merchant influence system 120 for representing consumer behavior.

Merchant influence system 120 may access data by requesting it from financial data system 115, or financial data system 115 may transmit the spending transaction data to merchant influence server 121 without prompting. The transaction data may be sent as a data stream, text file, serialized object, or any other method known in the art for transmitting data between computing systems. In some embodiments, financial data system 115 may expose an application programming interface (API) that it makes available to merchant influence system 120. To access transaction data, merchant influence system 120 may make a function call to the API to receive certain transaction data (e.g., spending transaction data). Those with skill in the art may contemplate additional methods for data transfer between merchant influence system 120 and financial data system 115 without changing the scope and sprit of the disclosed embodiments.

As noted above, the transaction data may include information regarding one or more consumer transactions. Transaction data for a consumer transaction may include, among other things, the date and time for the transaction, the purchase amount for the transaction, a unique customer identifier associated with the transaction, a description of the merchant for the transaction, a category code associated with the merchant (e.g., retail goods, medical services, dining), and geographic indicator (e.g., postal code, street address, GPS coordinates, etc.). In some embodiments, the transaction data may be processed to associate each transaction with a specific merchant, including a specific physical merchant location. If the transaction data for a particular transaction is incomplete and a specific merchant location is not determinable, additional processing may be implemented (e.g., based on user input and/or a predictive algorithm) to assign a specific merchant to the transaction. In other embodiments, transactions for which insufficient transaction data is available may be ignored by merchant influence system 120.

Further, consumer transactions reflected in the accessed transaction data may include several types of consumer transactions. For example, the consumer transactions may correspond to credit card purchases or refunds, debit card purchases or refunds, eChecks, electronic wallet transactions, wire transfers, etc. The consumer transactions may also include transactions associated with reward or loyalty programs. For example, the consumer transactions may include the number of loyalty points, and their cash equivalent, used to earn discounts or receive free dining.

After collecting consumer transaction data from the various sources (e.g., financial service provider 110, client device 130, and/or merchant(s) 140, one or more components of system 100 may store the transaction data for use in representing consumer behavior (step 320). For example, merchant influence system 120 may include a database (e.g., database 226) that compiles and stores all available consumer transaction data. In other embodiments, the consumer transaction data may be stored by financial data system 115 and selectively provided to merchant influence system 120. For example, merchant influence system 120 may request only certain stored transaction data from financial data system 115 to be used to represent consumer behavior.

When available data has been collected and stored, merchant influence system 120 may analyze the data to calculate the relative influence among merchants (step 330). In one embodiment, merchant influence server 121 may calculate the relative influence among merchants by comparing consumer transaction data of multiple merchants 140. The result of the relative influence calculation may be stored (either with or separately from the consumer transaction data) for use in representing consumer behavior.

In some embodiments, relative influence may be a numerical score that represents the co-occurrence of purchases by a common customer at two merchants 140. Co-occurrence of purchases by a common customer may refer to the quantity of transactions at one merchant 140 that were made by a customer that also made a transaction at another merchant 140. For example, for a given period of time, transaction data (including consumer information) may be available to merchant influence system 120 for consumer transactions at merchant A. In addition, transaction data may be available to merchant influence system 120 for consumer transactions at merchant B. In an exemplary embodiment, co-occurrence refers to a subset made up of transactions in the merchant A data set that were made by a customer that also made a transaction found in merchant B data set. Relative influence between two merchants may be calculated using a co-occurrence coefficient, such as a Tanimoto coefficient, which provides a numerical score representing the co-occurrence of transactions between two merchants.

In some embodiments, relative influence may be calculated and stored prior to a request by merchant influence system 120. For example, relative influence for particular merchants may be calculated and stored in financial data system 115. Relative influence may be constantly updated as additional transaction data is supplied (e.g., as more purchases are made). In other embodiments, relative influence may be calculated only after a request is made by merchant influence system 120. For example, merchant influence system 120 may supply relevant parameters (e.g., merchants, time period, customer criteria, etc.) and financial data system 115 (or other database in which transaction data is stored) may supply transaction data that fits the supplied parameters. In this embodiment, relative influence may be calculated for those merchants that were requested by merchant influence system 120.

After relative influence has been calculated for one or more selected merchants, merchant influence server 121 may produce a representation of consumer behavior based on the relative merchant influence calculated in step 330 (step 340). The representation may be a visual representation. For example, merchant influence server 121 may produce a topographical map that includes an element representative of the calculated relative influence among a physical space in which one or more merchants 140 reside. The element representative of the calculated relative influence may be a characteristic of consumer behavior, such as the effect relative locations of merchants have on a consumer's willingness to travel from one merchant to another. In additional embodiments, the representation may be a three-dimensional depiction of selected merchants 140 and the relative influence they have on each other.

The representation of consumer behavior generated in step 340 may be used as a tool to allow entities (such as financial service provider 110 and/or merchant(s) 140) to predict future consumer behavior (step 350). In one example, financial service provider 110 may use the visual representation to make decisions about what advertisements or deals may be useful to particular consumers. In another example, merchant 140 may use the visual representation in determining where new merchant locations may be successful or where they may be hampered by competition with other merchants that already exist in a particular area and have a particular influence on consumers in the area.

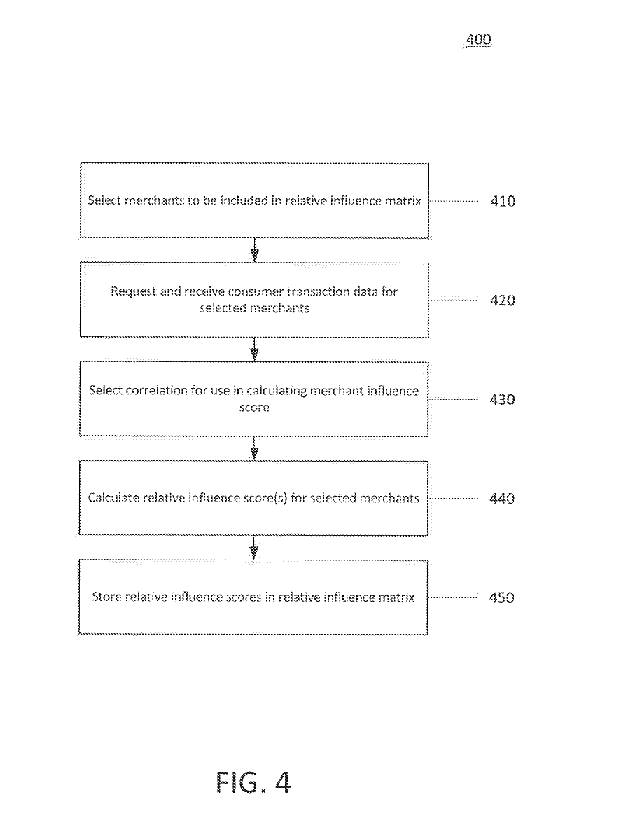

FIG. 4 is a flowchart of an exemplary process 400 for creating a relative influence matrix, consistent with disclosed embodiments. As described above, consumer transaction data may be collected, compiled, and stored in one or more components of system 100 (e.g., financial data system 115 and/or merchant influence server 121). The consumer transaction data may be continuously collected and stored for eventual use in process 400 to generate a relative influence matrix.

In some embodiments, generation of a relative influence matrix may be an automated process performed by a component of system 100 (e.g., merchant influence server 121). For example, merchant influence server 121 may be configured to periodically carry out process 400 to produce a relative influence matrix for a particular set of available transaction data. In other embodiments, merchant influence server 121 may only carry out process 400 when a user (e.g., user 122) makes a request.

In order to create a relative influence matrix, merchant influence server 121 may select the merchants for which relative influence will be calculated (step 410). The merchants may be selected in any manner in which a set of merchants for which relative influence can by calculated is produced. In one embodiment, selected merchants may be all merchants for which consumer transaction data is available. In other embodiments, selected merchants may be merchants that meet particular criteria. For example, the criteria may be a location within a particular region, a merchant type (e.g., retail stores, restaurants, etc.), or other subset of merchants for which consumer transaction data is available.

Merchant influence server 121 may continue process 400 by receiving transaction data for the selected merchants (step 420). As described above, merchant influence server 121 may receive the transaction data from another component of system 100, which may be a database (e.g., database 226) associated with one or more of financial service provider 110, financial data system 115, client device 130, and merchant 140. For example, merchant influence server 121 may place a request to a database associated with financial data system 115, which may provide consumer transaction data to merchant influence server 121 corresponding to the selected merchants.

In addition to receiving the consumer transaction data associated with the selected merchants, merchant influence server 121 may select an influence correlation to be used to calculate relative influence between merchants (step 430). In one embodiment, the selected influence correlation may be a Tanimoto coefficient. Other influence correlations that may be used in connection with the disclosed embodiments include Euclidean Distance measures, Jaccard coefficients, and Pearson coefficients. The Tanimoto coefficient may be a ratio of the subset of discrete customers that made a transaction with both of two merchants to a subset of discrete customers that made a transaction with exactly one of the two merchants over a given period of time. For example, if 100 customers made a transaction with merchant A and 200 customers made a transaction with merchant B over a given period of time, and 50 of those customers are common (i.e., made a transaction with both merchants A and B), the co-occurrence score for merchants A and B would be 50 (the customers in common)/200 (the customers distinct to either merchant A or merchant B), or 0.25, It should be understood that this calculation is exemplary and that other methods or algorithms may be selected for calculating relative influence between merchants. In the exemplary disclosed embodiment, relative influence is calculated between two merchants. However, it is contemplated that relative influence may be calculated between three or more merchants.

After the transaction data for the selected merchants has been received and the relative influence correlation has been selected, merchant influence server 121 may calculate relative influence for the selected merchants (step 440). For example, server 121 may select each merchant individually and, based on the supplied consumer transaction data, calculate relative influence of the selected merchant as compared to each of the other selected merchants. The results of each calculation may be stored in a relative influence matrix (step 450), The relative influence matrix may be stored by merchant influence server 121, which may include a database. In other embodiments, merchant influence server 121 may send the relative influence matrix information to another computing system within system 100 (e.g., financial data system 115) for storing the information.

Process 400 may be periodically carried out to continuously produce relative influence information that may be readily available for use by merchant influence system 120. For example, merchant influence system 120 may visually represent the information in a given relative influence matrix. This has been described above and will be described in more detail below. While process 400 describes the generation of a merchant influence matrix, it should be understood that the individual relative influence scores calculated in process 400 (or a similar process) may be stored separately and/or not necessarily in matrix-form. The relative influence matrix is exemplary and should be understood to embody the availability of a relative influence score for a given set of merchants.

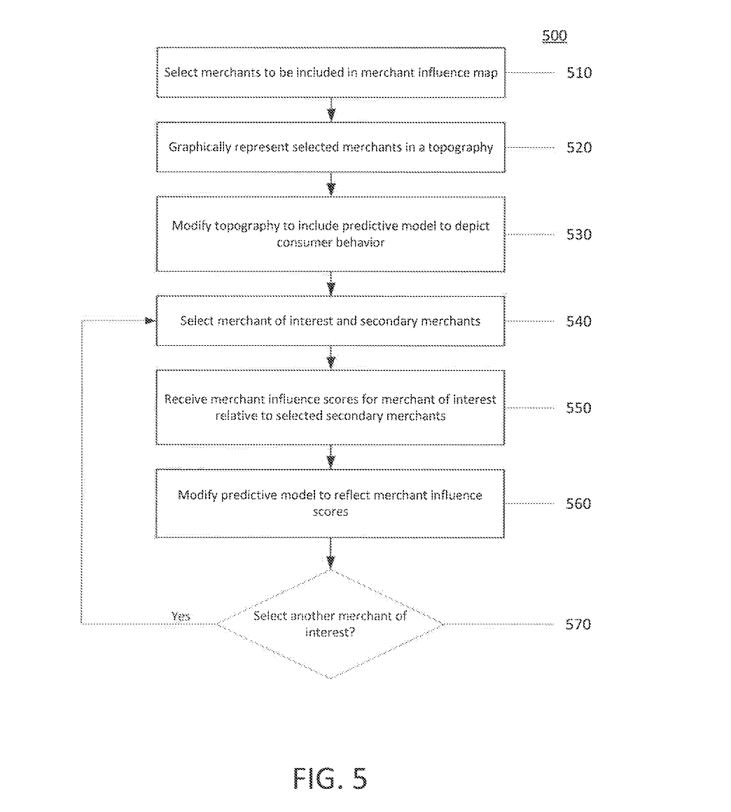

FIG. 5 is a flowchart of an exemplary process 500 for using relative influence data to represent consumer behavior by producing a visual representation of merchant influence in the form of a merchant map, consistent with disclosed embodiments. In one embodiment, merchant influence system 120 (e.g., merchant influence server 121) may execute instructions to perform process 500.

Process 500 may include merchant influence system 120 selecting a set of merchants to be included in a merchant influence map (step 510). In certain aspects, step 510 may be similar to step 410 of process 400. For example, merchant influence server 121 may receive a request to create a merchant influence map for a particular set of merchants 140. In one embodiment, server 121 may select the merchants according to input from a user 122. User 122 may select (via e.g., a graphical interface) merchants in any manner. For example, user 122 may select each specific merchant, one or more categories of merchants, merchants that are located within a particular area, or merchants via another process for selecting merchants that meet certain criteria (e.g., merchants for which a threshold amount of transaction data is available). In this way, consumer behavior as it relates to selected merchants may be represented. For example, merchants classified as retail stores may be separated from merchants classified as restaurants, so that consumer behavior may be analyzed in more specific scenarios. Merchant influence server 121 may receive a request that includes the merchants to be included in the merchant influence map.

After the merchants 140 have been selected, the selected merchants may be graphically represented in a topography (step 520) to create a base view for the merchant influence map. For example, server 121 may create a merchant map depicting the location of each selected merchant within a geographic space. The map may include only locations of selected merchants relative to each other, or it may include additional details, such as other entities (e.g., landmarks, streets, subway stations, etc.) that are located within the selected region of the map.

The map may be modified to include an indicator of consumer behavior (step 530). For example, the map may be modified to include a boundary of a region that represents an anticipated travel zone of a consumer. In one example, the boundary may be depicted as an enclosed shape, such as a circle, placed around each merchant included in the merchant map. The enclosed shape may represent a willingness of a consumer who makes a transaction at one merchant to travel to another merchant in the area. For example, upon traveling to a particular merchant, a consumer may be willing to walk 0.5 miles to make a transaction at another merchant. In this example, an enclosed shape, such as a circle with the selected merchant at the center, may include a 0.5 mile radius indicating that the average consumer will be willing to travel to a nearby merchant if they are located within the circle. In some cases, the willingness of the consumer to travel from a first merchant to a second merchant may be derived from a distance between the boundary around the first merchant and the location of the second merchant. To refine the model, multiple concentric boundaries may be placed around each merchant, with each larger boundary representing a decreasing likelihood of a consumer traveling to another merchant within that boundary.

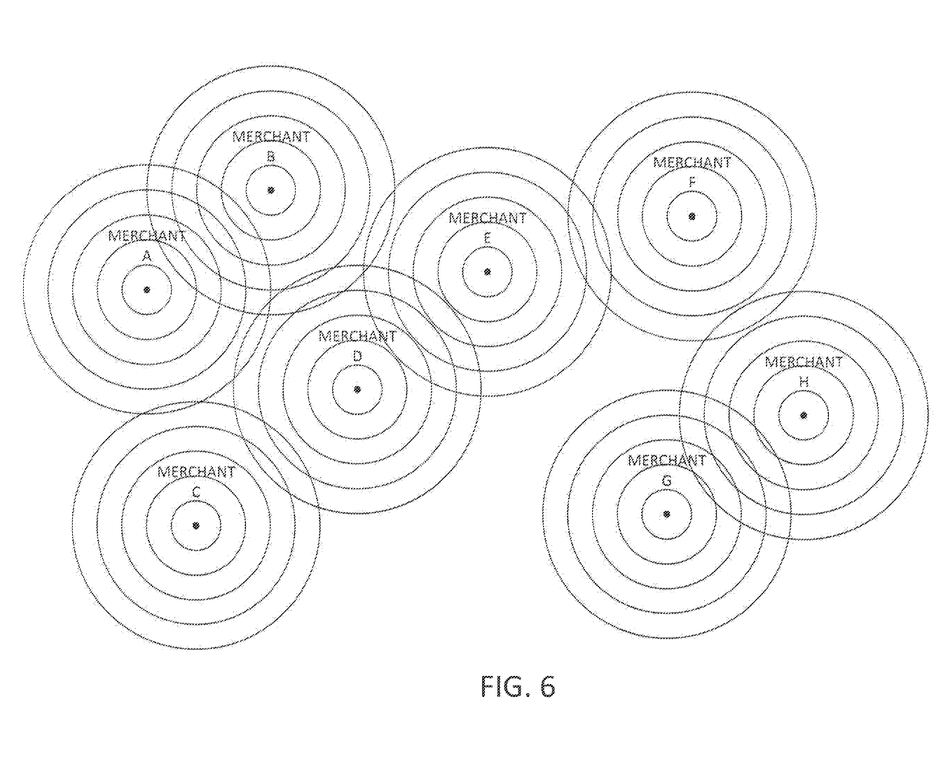

FIG. 6 depicts an exemplary merchant map with a concentric boundary indicator displayed around each selected merchant. In one embodiment, each selected merchant includes the same concentric boundary suggesting that a customer is willing to travel the same distance from each merchant to go to another merchant. In other embodiments, the boundaries may be tailored to particular merchants to more accurately reflect consumer behavior. For example, boundaries around particular merchants may be larger than boundaries around other merchants, to reflect that consumers may be willing to travel greater distances to go to some merchants.

In one embodiment, merchant influence server 121 may be configured to create the merchant map with concentric boundaries based on input from user 122. The user input may include, for example, the selected merchants and a decay function for the boundaries. The decay function may be an algorithm or calculation by which scale and relative positioning of the boundaries are determined. In some embodiments, the decay function may require geographic-specific profiles, depending on the characteristics of the area depicted in the map. For example, if the merchant map depicts a fairly large area that includes merchants that consumers generally drive between (e.g., a suburban area with several shopping centers) the decay function may pertain to the distance a consumer may be willing drive a vehicle to travel from one merchant to another merchant. In this way, the boundaries around each merchant may be spread out over a greater distance, representative of a consumer's willingness to drive between merchants. Similarly, if the merchant map depicts a smaller area such as a city block or shopping mall, the decay function may pertain to the distance a consumer may walk to travel to another merchant, which may include boundaries placed closer together, as compared to the decay function related to driving. In some embodiments, both walking and driving decay functions may be applied to create composite boundaries that take both possible forms of travel into account.

After the merchant map is created, merchant influence server 121 may modify the merchant map to reflect merchant influence. In one embodiment, merchant influence server 121 may distort the concentric boundaries to reflect the relative influence scores that were calculated in process 400 (or other process).

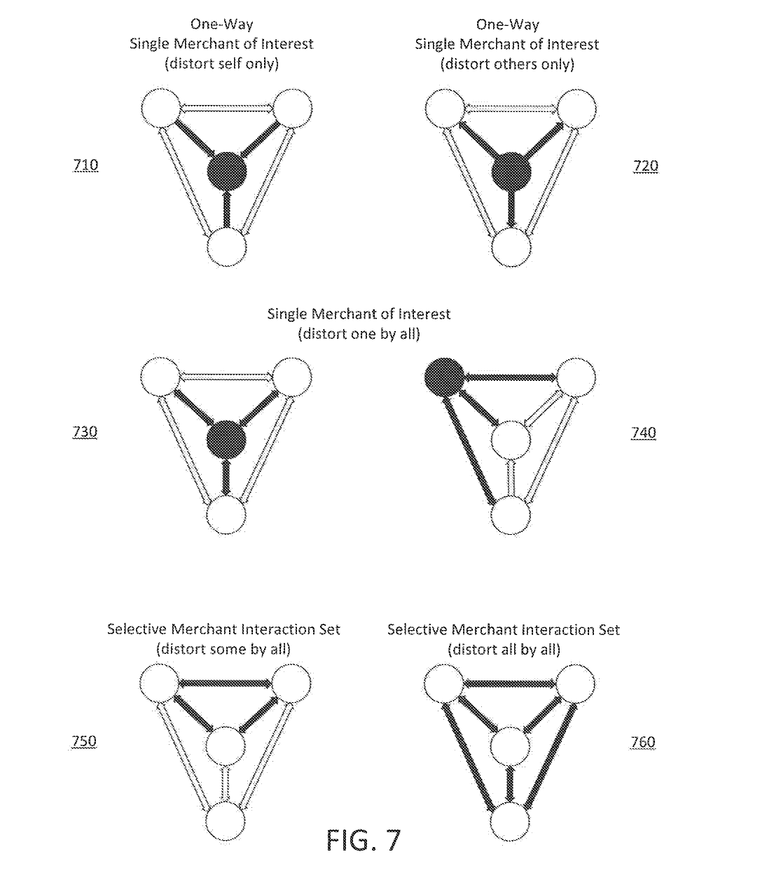

In the process 500, server 121 may select a merchant of interest (step 540) to begin modification of the merchant map. The merchant of interest may be the merchant for which the influence of nearby merchants may be compared. FIG. 7 depicts exemplary scenarios that may be considered when selecting merchant of interest. In some embodiments (e.g., scenarios 710, 720, 730, and 740), only one merchant of interest may be necessary to modify the merchant map. In other embodiments (e.g., scenarios 750 and 760), multiple merchants of interest may be selected to modify the merchant map. In scenarios 750 and 760, step 540 of process 500 may include selecting a first merchant of interest. Selection of subsequent merchants of interest will be described with more detail below. In some embodiments, the merchant of interest may be selected by merchant system 120 based on input from a user (e.g., user 122) via a menu or other form of I/O (click, touch, gesture).

After the merchant of interest (or first merchant of interest) has been selected, server 121 may associate a relative influence score with each selected (secondary) merchant in the merchant map, as compared with the merchant of interest (step 550). For example, the relative influence score for each secondary merchant may be the co-occurrence coefficient calculated in step 440 of process 400. Server 121 may receive each coefficient score from a computing system that stores the relevant relative influence score, such as a relative influence matrix (e.g., the relative influence matrix created in process 400). In other embodiments, server 121 may receive transaction data regarding the selected merchant of interest and secondary merchants, and calculate the relative influence score based on the received transaction data.

In the embodiment in which server 121 receives the transaction data instead of the pre-calculated relative influence scores, the transaction data may be filtered to include particular transactions in the relative influence scores. For example, the transaction data may be filtered by transaction criteria (e.g., date of transaction, product purchase v. other transaction, type of produce purchased, transaction amount, etc.), consumer criteria (e.g., individual v. entity, consumer age, consumer gender, etc.), or other characteristic that can be used to subdivide the available transaction data. The filtering criteria may be programmatically selected by server 121 or inputted by a user 122. In this embodiment, after the transaction data has been received, server 121 may calculate relative influence scores based on the filtered transaction data.

After the relative influence scores have been associated with the merchant map, the boundaries may be distorted to reflect the relative influence scores (step 560). In an exemplary embodiment, the concentric boundaries around two selected merchants (the merchant of interest and a secondary merchant) may be distorted to reflect the relative influence score between the two merchants. For example, the concentric boundaries around each merchant may be distorted towards the other merchant by an amount proportional to the relative influence score between the two merchants. In one exemplary embodiment, each boundary is initially comprised of a predetermined number of points (e.g., 16) along the circumference of a circle, connected by a curved line. To distort the boundaries, an angle between two merchant locations may be used to select the point on the boundary around one merchant location that is nearest to the other merchant location. The selected point may be moved towards the other merchant location by an amount proportional to the influence score (such as by linear interpolation). Other boundary points may also be adjusted to provide an even curve.

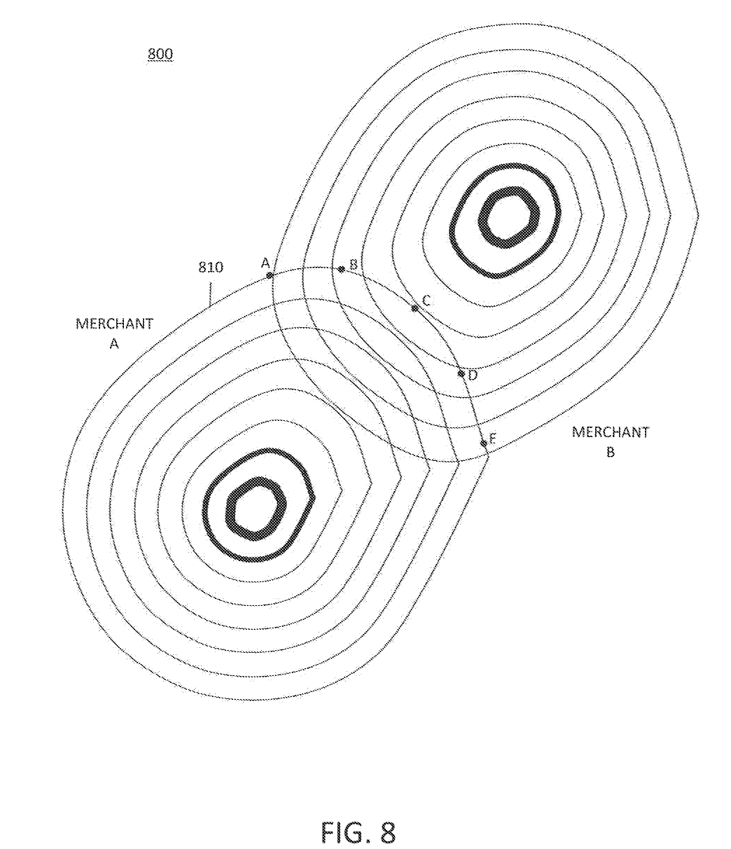

FIG. 8 depicts an exemplary merchant map with merchant A and merchant B, detailing the above exemplary manner in which a boundary 810 around merchant A may be distorted towards merchant B. For example, as shown in FIG. 8, boundary 810 may include points A, B, C, D, and E, which form an arc of boundary 810. Point C may be the point determined to be the point nearest merchant B. Point C may be interpolated towards merchant B by a distance (e.g., an inverse distance between merchants A and B) scaled by a factor of 0.25, which may be the relative influence between merchants A and B. Points B and D may be interpolated towards Merchant B by the same distance, scaled by a factor of (0.25)/X, and A and E may be interpolated towards Merchant B by the same distance, scaled by a factor of (0.25)/Y, where X and Y are calculated such that points A, B, D, and E, are moved a distance sufficient to smooth the distorted boundary 810.

As described above, the distance by which each boundary is distorted (and by which the relative influence score is used to scale) may correspond to a proximity of the merchants whose boundaries are being distorted, such as an inverse distance between the merchants. In this way, if two merchants have the same relative influence score as compared to a particular merchant of interest, the merchant that is closer to the merchant of influence may have its boundaries distorted to a greater degree than the secondary merchant that is further away. Other distances by which boundaries may be distorted are also contemplated, such as a predetermined distance for each merchant, or a scaled distance depending on an attribute of the particular merchant.

Step 560 may continue with the distortion of each boundary for which a merchant influence score was associated with the merchant of interest in step 550. For example, each boundary around the merchant of interest may be distorted with respect to each other merchant in the merchant map. Depending on the selected parameters of the merchant map, each boundary around each other merchant may also be distorted with respect to the selected merchant of interest. The selected parameters may correspond to the scenarios depicted in FIG. 7. For example, in scenario 710, only the boundaries around the merchant of interest are distorted. In scenario 720, only the boundaries around the other merchants (i.e., all but the merchant of interest) are distorted. In scenarios 730 and 740, both the merchant of interest and the other merchants are distorted towards each other.

Process 500 may continue by determining if there are additional merchants of interest to be selected for further modification of the merchant map (step 570). In some embodiments (e.g., scenarios 710, 720, 730, and 740), the merchant map, modified to reflect the relative influence scores of a single merchant of interest, may be a sufficiently useful representation of consumer behavior as it relates to relative influence of the secondary merchants in the map relative to the merchant of interest. In these embodiments, process 500 ends without selecting another merchant of interest. In other embodiments (e.g., scenarios 750 and 760), process 500 may continue by selecting another merchant of interest to further modify the merchant influence map. Process 500 may repeat steps 510-560 with each subsequent merchant of interest until all desired boundary distortions have been made. It is further contemplated that multiple versions of a distorted merchant map (e.g., multiple scenarios depicted in FIG. 7 created by process 500) may be layered, such as by server 121, to create a total influence map, which may be displayed to user 122, and with which user 122 may interact via an I/O device (e.g., to switch between or select particular layers for display).

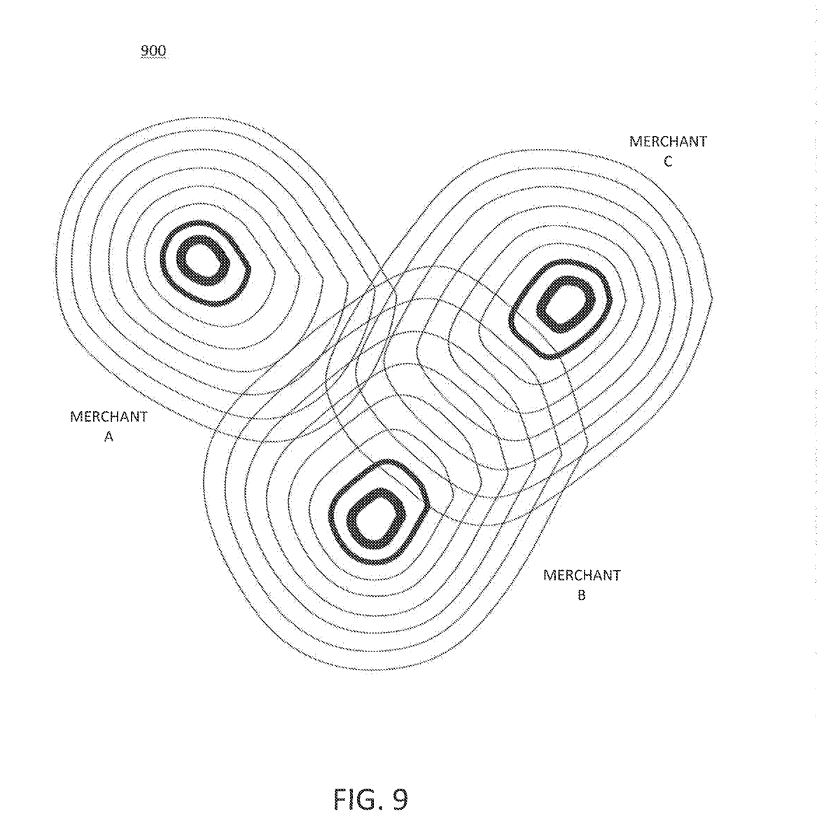

FIG. 9 depicts an exemplary merchant map 900, with three merchants A, B, and C. In one embodiment, Merchant A may be selected first as the merchant of interest. Thereafter, merchant influence server 121 may distort the boundaries around merchant A and B according to the relative influence score between merchants A and B. Merchant influence server 121 may subsequently (or simultaneously) distort the boundaries around merchant C and further distort the boundaries around merchant A, according to the relative influence score between merchants A and B. In this way, the merchant of interest may include distorted boundaries that depict the influence merchants in the area have on consumers and their behavior. This example may correspond to scenario 730 of FIG. 7, in which all boundaries are distorted with respect to a single merchant of interest.

Further, merchant influence server 121 may select merchant B as the next merchant of interest. Merchant influence server 121 may further distort the boundaries around merchants B and C according to a received relative influence score between merchants B and C. In this way, relative influence of each merchant with regard to each other merchant in merchant map 900 may be depicted. This may correspond to scenario 760 of FIG. 7, in which all boundaries are distorted with respect to each other merchant in the map.

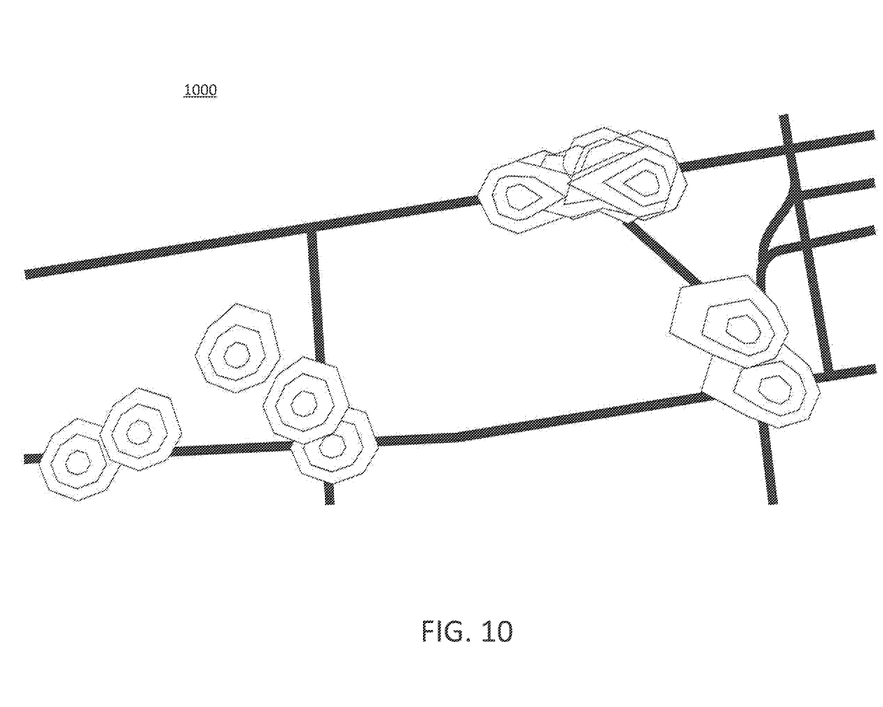

FIG. 10 depicts an exemplary merchant influence map 1000 that has had all merchant boundaries distorted with respect to a single merchant of interest in a particular area. FIG. 10 depicts an example of scenario 720 of FIG. 7.

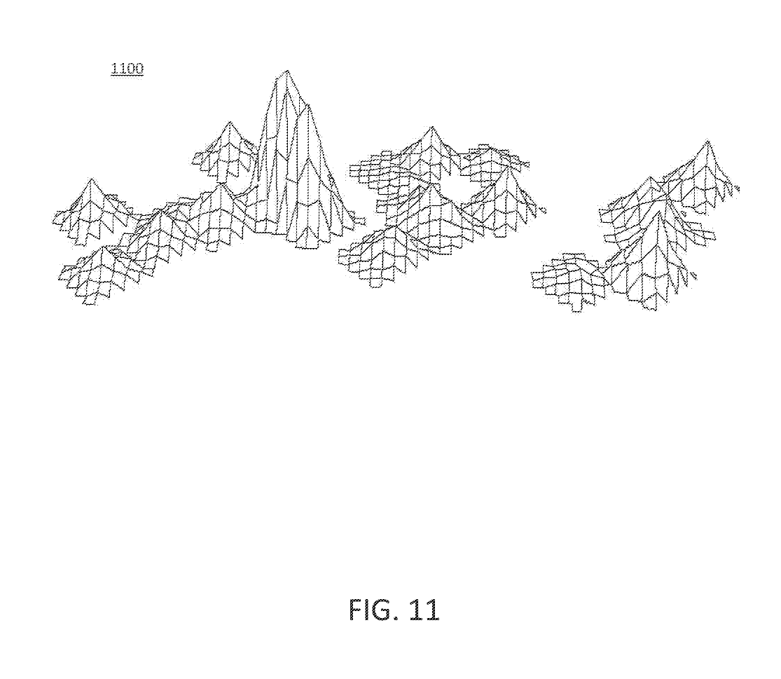

Additional embodiments of process 500 may include additional steps to use the generated merchant influence map to create a three-dimensional visual representation. The three-dimensional version may be a physical space depiction of a merchant map that illustrates the relative influence scores between merchants shown in the depiction. Such spaces may be generated by interpreting the merchant boundaries as a topological map so that boundaries closer to the actual merchant location indicate the highest elevation and subsequent boundaries indicate increasingly lower levels of elevation. In the exemplary disclosed embodiment, the closer such boundaries are together, the steeper the slope between boundaries. FIG. 11 depicts an exemplary embodiment of a three-dimensional merchant influence map 1100.

Three-dimensional representations of this sort may be used in the context of analytics with immersive display technology, augmented reality visualizations, and simulations such as modeling crowd behavior through a market-space using an off-the-shelf physics engine like Unity3D. Other representations of an influence map in three-dimensional space may include visualizing typical consumer behaviors to other consumers through augmented reality applications (i.e. Google glass, mobile cameras, etc.). Intensity, colors, arrows and other indicators may be included to show a consumer how others have behaved after having made a similar transaction in a similar location by projecting the data into a three-dimensional view relative to the user's line of sight. This may be used by merchants to better understand their typical consumer profile in terms of where they may shop next.

As described above, the exemplary merchant influence maps 800, 900, 1000, and 1100 may be used to predict consumer behavior and avail entities of additional information upon which decisions may be based. For example, a merchant 140 may generate merchant influence map 1000 and observe that consumers are drawn toward a central area that includes several merchants, and appear more willing to travel to some locations more than others near the central area. The merchant may use merchant influence map 900 by basing a decision on where to open a new merchant location on this observation.

In other embodiments an entity, such as financial service provider 110, may use merchant influence map 1000 to provide deals and/or recommendations to users (e.g., user 132). For example, a financial service provider may recognize that a particular merchant or area draws customers from other merchants or areas and provide deals or recommendations based on that information to encourage (or discourage) particular consumer behavior. In this way, the financial service provider may be able to make decisions on which merchants to provide deals for and/or recommend. In other examples, a financial service provider may generate additional services for merchant-partners such as deals that scale based on a combination of proximity and influence-map (i.e. $1 off if the customer is within 0.5 miles and $2 if they are within 1 mile).

Additional exemplary uses of the disclosed merchant influence maps may include the potential for city-planners to model vehicular and pedestrian traffic flows.

Further exemplary uses may include use of an influence matrix (e.g., an influence matrix created via exemplary process 400) as an input for other possible uses of customer behavior. For example, a merchant influence matrix may be used to normalize customer profiles by distinguishing between geographic-based purchase choices versus absolute or abstract purchase choices.

The exemplary disclosed embodiments describe systems and methods that allow available transaction data to be used to represent consumer behavior to assist entities in making various decisions. The foregoing description has been presented for purposes of illustration. It is not exhaustive and is not limited to the precise forms or embodiments disclosed. Modifications and adaptations of the embodiments will be apparent from consideration of the specification and practice of the disclosed embodiments. For example, the described implementations include hardware and software, but systems and methods consistent with the present disclosure can be implemented as hardware alone.

Computer programs based on the written description and methods of this specification are within the skill of a software developer. The various programs or program modules can be created using a variety of programming techniques. For example, program sections or program modules can be designed in or by means of Java, C, C++, assembly language, or any such programming languages. One or more of such software sections or modules can be integrated into a computer system, computer-readable media, or existing communications software.

Moreover, while illustrative embodiments have been described herein, the scope includes any and all embodiments having equivalent elements, modifications, omissions, combinations (e.g., of aspects across various embodiments), adaptations or alterations based on the present disclosure. The elements in the claims are to be interpreted broadly based on the language employed in the claims and not limited to examples described in the present specification or during the prosecution of the application, which examples are to be construed as non-exclusive. Further, the steps of the disclosed methods can be modified in any manner, including by reordering steps or inserting or deleting steps. It is intended, therefore, that the specification and examples be considered as example only, with a true scope and spirit being indicated by the following claims and their full scope of equivalents.

What is claimed is:

1. A system for representing consumer behavior, comprising:
one or more memory devices storing software instructions; and
one or more processors configured to execute the software instructions to:
receive consumer transaction data associated with financial transactions occurring with a first merchant and financial transactions occurring with a second merchant;
calculate, by the one or more processors, a relative influence score between the first and second merchants based at least on the consumer transaction data; and
generate, by the one or more processors, a graphical representation of the first and second merchants and the relative influence score.

2. The system of claim 1, wherein the one or more processors is further configured to select the first and second merchants based on selected criteria associated with a desired feature.

3. The system of claim 2, wherein the selected criteria includes at least one of a particular geographic area or a merchant type.

4. The system of claim 1, wherein the one or more processors is further configured to:
filter the received consumer transaction data based on at least one of transaction criteria or consumer criteria; and
calculate the relative influence score based on the filtered consumer transaction data.

5. The system of claim 1, wherein calculating the relative influence score includes calculating the relative influence score based on a correlation comprising one of a Tanimoto coefficient, a Euclidean Distance measure, a Jaccard coefficient, and a Pearson coefficient.

6. The system of claim 1, wherein generating a graphical representation includes:
generating a merchant map depicting the relative location of each of the first and second merchants;
modifying the merchant map to include a boundary associated with each of the first and second merchants.

7. The system of claim 6, wherein generating a graphical representation further includes modifying at least the boundary associated with the first merchant to reflect the relative influence score.

8. The system of claim 7, wherein:
the boundary associated with the first merchant represents a willingness of a consumer to travel from the first merchant to the second merchant; and
modifying the boundary associated with the first merchant to reflect the relative influence score includes distorting the boundary to move a portion of the boundary closer to the second merchant by an amount proportional to the relative influence score.

9. The system of claim 8, wherein the one or more processors is further configured to:
receive consumer transaction data associated with financial transactions that occurred with a third merchant;
calculate a relative influence score between the first and third merchants based on the consumer transaction data; and
wherein generating a graphical representation includes:
generating a merchant map that depicts the relative location of each of the first, second, and third merchants, and
modifying the merchant map to include a boundary associated with each of the first, second, and third merchants.

10. The system of claim 9, wherein generating a graphical representation further includes modifying at least the boundary associated with the first merchant to reflect the relative influence scores.

11. The system of claim 10, wherein the boundary around the first merchant represents a willingness of a consumer to travel from the first merchant to the second and third merchants, and modifying the boundary associated with the first merchant to reflect the relative influence scores includes distorting the boundary to move a portion of the boundary closer to the second merchant by an amount proportional to the relative influence score between the first and second merchant, and further distorting the boundary to move a portion of the boundary closer to the third merchant in an amount proportional to the relative influence score between the first and third merchant.

12. The system of claim 9, wherein the one or more processors is further configured to:
calculate a relative influence score between the second and third merchants;
select one of the first, second, and third merchants as a merchant of interest; and
modify the boundary around the merchant of interest to reflect the relative influence scores.

13. A computer-implemented method for representing consumer behavior, comprising:
receiving, by one or more processors, consumer transaction data associated with financial transactions occurring with a first merchant and financial transactions occurring with a second merchant;
calculating, by the one or more processors, a relative influence score between the first and second merchants based on the consumer transaction data;
generating, by the one or more processors, a graphical representation of the first and second merchants and the relative influence score; and
wherein generating a graphical representation includes:
generating a merchant map that depicts the relative location of each of the first and second merchants,
modifying the merchant map to include a boundary associated with each of the first and second merchants, and
modifying at least the boundary associated with the first merchant to reflect the relative influence score.

14. The computer-implemented method of claim 13, wherein the one or more processors is further configured to select the first and second merchants based on selected criteria associated with a desired feature.

15. The computer-implemented method of claim 14, wherein the selected criteria includes at least one of a particular area and a merchant type.

16. The computer-implemented method of claim 13, wherein the one or more processors is further configured to:
filter the received consumer transaction data based on transaction criteria and/or consumer criteria; and
calculate the relative influence score based on the filtered consumer transaction data.

17. The computer-implemented method of claim 13, wherein calculating the relative influence score includes calculating the relative influence score based on a correlation comprising one of a Tanimoto coefficient, a Euclidean Distance measure, a Jaccard coefficient, and a Pearson coefficient.

18. The computer-implemented method of claim 13, further including:
receiving, by the one or more processors, consumer transaction data associated with financial transactions that occurred with a third merchant; and
calculating a relative influence score between the first and third merchants, and the second and third merchants, based on the consumer transaction data.

19. The computer-implemented method of claim 18, wherein:
generating the merchant map further includes representing the relative location of the first, second, and third merchants,
modifying the merchant map includes modifying the merchant map to include a boundary associated with the third merchant, and
modifying the boundaries associated with the first, second, and third merchants to reflect the relative influence scores.

20. A non-transitory computer-readable medium including instructions that, when executed by a processor, causes the processor to perform operations comprising;
receiving consumer transaction data associated with financial transactions occurring with a first merchant and financial transactions occurring with a second merchant;
calculating a relative influence score between the first and second merchants based on the consumer transaction data; and
generating a graphical representation of the first and second merchants and the relative influence score.
